(19) United States
(12) Patent Application Publication
(10) Pub. No.: US 2024/0372227 A1
(43) Pub. Date: Nov. 7, 2024

(54) DEVICE FOR CONNECTING A TERMINAL OF A BATTERY MODULE TO AN ELECTRICAL CONDUCTOR

(71) Applicant: A Raymond et Cie, Grenoble (FR)

(72) Inventor: David Lamoureux, Grenoble (FR)

(21) Appl. No.: 18/291,392

(22) PCT Filed: Jun. 9, 2022
(86) PCT No.: PCT/FR2022/051096

§ 371 Date: Jan. 23, 2024

(30) Foreign Application Priority Data
Jul. 23, 2021 (FR) FR2107979

(51) Int. Cl. H01M 50/517; H01M 50/503; H01R 4/48; H01R 13/641

(52) U.S. Cl. CPC H01M 50/517; H01M 50/503; H01R 4/48; H01R 13/641; H01M 2220/20

(57) ABSTRACT

A device for connecting a terminal of a battery module to an electrical conductor comprises a longitudinal insulation body having at least one housing for receiving the terminal, and an electrical conductor arranged in the longitudinal insulation body. The connection device further comprises a connection arrangement including an electrical connector configured to be inserted into the housing and to make electrical contact between the terminal and the electrical conductor in order to electrically connect them, and a latch. A visual lock indicator is disposed on the longitudinal insulation body so as to be at least partially concealed by the latch in a first latch position and to be fully exposed in a second latch position.

### CROSS-REFERENCE TO RELATED APPLICATIONS

This application is a national phase entry under 35 U.S.C. § 371 of International Patent Application PCT/FR2022/051096, filed Jun. 9, 2022, designating the United States of America and published as International Patent Publication WO 2023/002096 Al on Jan. 26, 2023, which claims the benefit under Article 8 of the Patent Cooperation Treaty of French Patent Application Serial No. FR2107979, filed Jul. 23, 2021.

### TECHNICAL FIELD

The present disclosure relates to a connection device for electrically connecting a terminal of a battery module to an electrical conductor. This conductor can make it possible to electrically connect several modules to one another. The present disclosure finds a very particular application in the field of electric vehicles.

### BACKGROUND

In high-voltage electrical energy storage systems, in particular, those used in electric vehicles, it is usual to combine several battery cells to form individual battery modules. Each module usually comprises two terminals or terminals having different poles. The battery modules are connected to each other, that is to say placed in electrical contact with one another, via a busbar, generally made of copper.

Usually, a busbar is screwed or soldered to the terminals of the modules that it connects, which is not always suitable for high manufacturing volume. The document WO2019242917 discloses a connection device that is pluggable on terminals. Two holding clips make it possible to form an electrical contact between the busbar and the terminals. The assembly is arranged in an insulating longitudinal body.

### BRIEF SUMMARY

An object of the present disclosure is to propose a device for connecting a terminal of a battery module to an electrical conductor that is secure, that is to say provided with means that prevent the electrical disconnection of the device and/or whose correct assembly can be visually observed.

In order to achieve this object, the subject matter of the present disclosure proposes a device for connecting a terminal of a battery module to an electrical conductor, the connection device comprising:
a longitudinal insulation body having at least one terminal receiving housing, the longitudinal body having, on a first face, a first opening for insertion of the terminal into the receiving housing and, on a second face opposite the first, a second opening for insertion of an electrical connector, the second insertion opening into the receiving housing; and
an electrical conductor arranged in the longitudinal body.

The connection device also comprising a connection arrangement formed by at least the following elements:
an electrical connector configured to fit into the second insertion opening and to electrically contact the terminal and the electrical conductor so as to electrically connect them together;
a latch arranged at least on the second face of the longitudinal body and adapted to move longitudinally between a first latch position, wherein the second insertion opening is exposed to allow the insertion of the electrical connector, and a second latch position, wherein the latch at least partially overhangs the second insertion opening to lock the electrical connector in the receiving housing; and
a visual lock indicator arranged on the longitudinal body so as to be at least partially concealed by the latch in the first latch position and fully exposed in the second latch position.

According to other advantageous and non-limiting features of the present disclosure, either individually or in any technically feasible combination:
the receiving housing is arranged at a first end of the longitudinal body;
the longitudinal body comprises a second end opposite the first and wherein the electrical conductor extends from a first end to the second end;
the second end forms a second terminal receiving housing, the longitudinal body having, on its first face, two first terminal insertion openings in their respective receiving housings and, on the second face, two second insertion openings for electrical connectors, the two second insertion openings opening respectively into the receiving housings, the connection device comprising two connection arrangements respectively associated with the receiving housings;
the electrical conductor comprises a busbar provided at its end with a rigid conductive plate;
the electrical connector comprises a metal jaw for enclosing the electrical conductor against the terminal;
the jaw is held in a pusher part shaped to the second insertion opening.

### BRIEF DESCRIPTION OF THE DRAWINGS

Other features and advantages of the present disclosure will emerge from the following detailed description of embodiments of the present disclosure with reference to the appended figures, in which:

FIG. 1 is a perspective view of a plurality of battery modules connected by connection devices;

FIGS. 2A, 2B, 3A and 3B represent views of a connection device 100 of one embodiment;

FIG. 4 shows the use of a connection device 100 according to the present disclosure.

### DETAILED DESCRIPTION

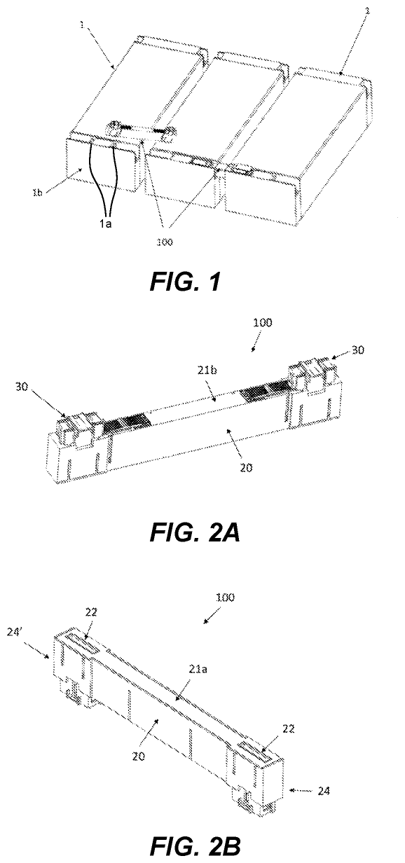

As an introduction to embodiments of the present disclosure, FIG. 1 shows a plurality of battery modules 1 connected to one another by connection devices 100. As is conventional, each module 1 has two terminals (not visible in FIG. 1) here in the form of a terminal consisting of a protruding metal plate la, arranged in a module interface 1b front portion. Of course, the modules 1 of FIG. 1 are presented by way of illustration only and, generally, a connection device according to the present disclosure is compatible with any module shape or configuration, so long as such a module has at least one terminal. This at least one terminal may take other shapes than the one, in a projecting metal plate la, shown in FIG. 1. It may, in particular, be a U-shaped metal plate.

In a very general manner, the connection device 100 of FIG. 1 makes it possible to electrically connect a terminal of a first battery module, to another terminal, this other terminal being able to be that of a second battery module.

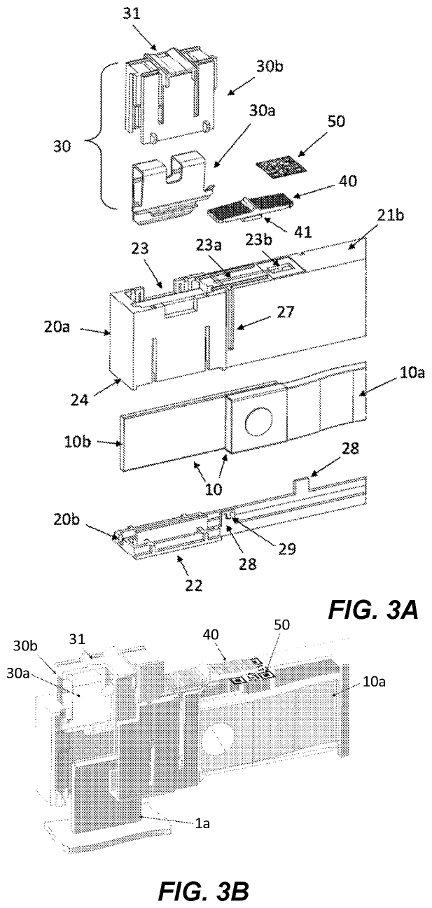

FIGS. 2A, 2B, 3A and 3B represent views of a connection device 100 according to one embodiment. This connection device 100 comprises a longitudinal insulation body 20 (more simply referred to as a longitudinal body in the rest of this description), typically made of a plastic material. As best shown in FIG. 3A, the longitudinal body 20 is formed, in the embodiment shown, of a first part 20a and of a second facade part 20b assembled to each other, for example, by clipping. To this end, the facade part 20b is provided with flexible tongues 28 respectively bearing notches 29 intended to elastically engage in fastening grooves 27 provided on the first part 20a. Of course, any other mechanism for assembling the first part 20a to the facade part 20b may be suitable.

The longitudinal body 20 is, in particular, intended to receive an electrical conductor 10 that it is intended to connect to at least one terminal of a battery module 1, in order to isolate this conductor from any outside access. The longitudinal body 20 has at least one terminal receiving housing. In the embodiment shown, the longitudinal body 20 comprises two receiving housings 24, 24′ (FIG. 2B) arranged respectively at a first and at a second end of the longitudinal body 20. However, this arrangement is in no way mandatory, and a connection device could be provided, according to other embodiments, comprising a different number of receiving housings, arranged at other locations of the longitudinal body 20.

Regardless of the number of receiving housings provided, the longitudinal body 20 has a first face 21a (FIG. 2B), corresponding here to the exposed face of the facade part 20b, provided with a first terminal insertion opening 22 of a battery module. The longitudinal body 20 also has a second face 21b (FIG. 2A), opposite the first face 21a, provided with a second insertion opening 23 (FIG. 3A). This second insertion opening 23 makes it possible to insert an electrical connector 30 into the receiving housing 24 to electrically contact the electrical conductor 10 and the terminal, as will be described in detail in the remainder of this description.

As has already been mentioned, the connection device 100 comprises an electrical conductor 10 housed in the longitudinal body 20. One end of this electrical conductor 10 lies in the receiving housing 24 in order to allow its electrical connection to the terminal, when the connection device 100 is suitably plugged onto a battery module. In the case of the bipolar connection device 100 of the embodiment shown, the electrical conductor extends from a first end of the longitudinal body 20 to a second end of the longitudinal body 20, so that the electrical conductor 10 occupies at least part of each terminal receiving housing 24, 24′.

The electrical conductor 10 may be formed by a busbar 10a, onto which a rigid conductive plate 10b has been attached at the end, facilitating the electrical contact of the electrical conductor 10 with the terminal in the receiving housing. The facade part 20b is here provided, on its inner face intended to receive the electrical conductor 10, with retaining ribs making it possible to precisely position the electrical conductor 10 in the longitudinal body 20. In particular, it is sought to position the rigid conductive plate 10b in close proximity to the first terminal insertion opening 22.

In order to electrically connect the electrical conductor 10 and the module terminal inside the receiving housing 24, the connection device also comprises an electrical connector 30 whose general shape is configured to be inserted into the second insertion opening 23 and at least partially occupy the receiving housing 24.

In general, the connection device 100 comprises as many electrical connectors 30 as there are receiving housings 24, 24′.

An electrical connector 30 comprises a metal jaw 30a to jointly clamp the electrical conductor 10 and the terminal, and press them firmly against one another. This metal jaw 30a can be held by an insulating push piece 30b formed at the second insertion opening 23.

When the electrical connector 30 is suitably inserted by the second insertion opening 23 in the second face 21b of the longitudinal body 20 to occupy the receiving housing 24, the metal jaw 30a forces the electrical contact between the electrical conductor 10 and the terminal.

It is of course possible to provide an electrical connector 30 having another configuration than that presented in this embodiment, in particular, according to the shape and nature of the terminal of the battery module.

In all cases, the electrical connector 30 ensures the bringing into contact and holding of this electrical contact between the terminal and the electrical conductor 10, when this electrical connector 30 and the terminal are suitably inserted into the respective openings of the longitudinal body to both occupy the receiving housing 24.

To secure this connection position of the electrical connector 30, the connection device 100 comprises a latch 40 (FIG. 3A) arranged at least on the second face 21b of the longitudinal body 20. The latch 40 is able to move longitudinally between a first latch position wherein the second insertion opening 23 is exposed and a second latch position wherein the latch at least partially overhangs the second insertion opening 23. In the position in which the second opening is exposed, the electrical connector 30 can be inserted. In the second locking position the electrical connector 30 is locked in the receiving housing 24 and cannot be extracted therefrom.

The second face 21b may be provided with a guide groove 23a configured to guide the longitudinal movement of the latch 40. A foot 41 of the latch connected to the upper locking part by a narrow leg can be inserted into a slot 23b provided on the second face 21b, in order to allow the narrow leg to slide in the guide groove 23a. Of course, any other mechanism for guiding the latch 40 longitudinally on the longitudinal body 20 may be suitable.

Finally, a connection device 100 in accordance with the embodiment that is the subject of the present description comprises a visual lock indicator 50. This visual lock indicator 50 is disposed on the longitudinal body 20. In the selected arrangement, the visual lock indicator 50 is at least partially obscured by the latch 40 in the first latch position (“open” position of the insertion opening) and fully exposed in the second latch position (“closed” position of the insertion opening). Thus, it is possible to observe with ease the good electrical connection between the electrical conductor and the terminal, as well as the compliant, secure locking of the electrical connector 30.

The visual lock indicator 50 may be of any color, including yellow, green, red, white, blue, black, orange, violet, such that it is particularly visible in its environment. The visual lock indicator 50 may include a reflective tape or a sticker or printing displaying a pattern, color, barcode, reflective material, label or alphanumeric message.

In some embodiments, the visual lock indicator 50 comprises a code, such as a one-dimensional barcode (for example, UPC code, EAN code, code 39, code 128, ITF, code 93, codabar, GS1 databar, MSI Plessey, etc.), a two-dimensional barcode (for example, QR code, datamatrix code, PDF417, AZTEC, etc.), a holographic code, a human-readable alphanumeric code, other codes known in the art and interpretable by a machine equipped with a vision device and/or an operator.

As used herein, the term “connection arrangement” refers to the combination formed by an electrical connector 30, a latch 40 and a visual lock indicator 50, this combination being associated with a receiving housing 24. As has already been indicated, a connection device 100 generally comprises as many connection arrangements as receiving housings, two in the described bipolar implementation mode.

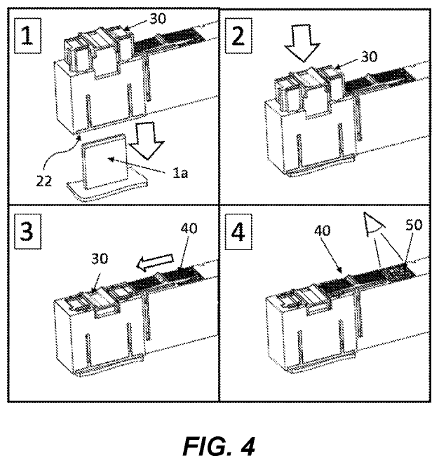

The use of a connection device 100 is described with reference to FIG. 4.

In a first step, the connection device 100 is plugged into a terminal of a battery module 1 or into two terminals of two modules if it is a bipolar device. The terminal penetrates through the first terminal insertion opening 22 to occupy the receiving housing 24. The electrical connector 30 is partially inserted into the receiving housing, through the second insertion opening 23, in a delivery position. In this position, the latch 40 is in the first position and completely releases or exposes the opening. It at least partially masks the visual lock indicator 50.

In a second step, the electrical connector 30 is completely inserted into the receiving housing in order to place the terminal and the electrical conductor 10 in electrical contact as described above. At the end of this step, the upper surface of the electrical connector 30 is flush with the second face 21b of the longitudinal insulation body 20, or even arranged slightly under this face, which makes it possible to release the translational movement of the latch 40. The latter can therefore be moved into the second position wherein it partially overhangs the second insertion opening 23 to lock the electrical connector 30 in the receiving housing 24. In doing so, and as can be seen clearly on the insert 4 of FIG. 4, the visual lock indicator 50 is completely exposed. “Completely” means that it is possible to detect without ambiguity the presence of this indicator or of the code that it may carry.

Of course, the present disclosure is not limited to the embodiment described and variant embodiments can be added thereto without departing from the scope of the invention as defined by the claims.

1. A connection device for connecting a terminal of a battery module to an electrical conductor, the connection device comprising:
a longitudinal insulation body in which the electrical conductor is disposed, the longitudinal insulation body having at least one terminal receiving housing, the longitudinal insulation body having, on a first face, a first opening for insertion of the terminal into the receiving housing and, on a second face opposite the first face, a second insertion opening for insertion of an electrical connector, the second insertion opening opening into the receiving housing; and
a connection arrangement including:
an electrical connector configured to fit into the second insertion opening and to electrically contact the terminal and the electrical conductor so as to electrically connect them together;
a latch arranged at least on the second face of the longitudinal insulation body and adapted to move longitudinally between a first latch position in which the second insertion opening is exposed to allow the insertion of the electrical connector, and a second latch position in which the latch at least partially overhangs the second insertion opening to lock the electrical connector in the receiving housing; and
a visual lock indicator disposed on the longitudinal insulation body so as to be at least partially concealed by the latch in the first latch position and fully exposed in the second latch position.

2. The connection device of claim 1, wherein the receiving housing is disposed at a first end of the longitudinal insulation body.

3. The connection device of claim 2, wherein the longitudinal insulation body comprises a second end opposite the first end, and wherein the electrical conductor extends from the first end to the second end of the longitudinal insulation body.

4. The connection device of claim 3, wherein the second end forms a second terminal receiving housing, the longitudinal insulation body having, on its first face, two first terminal insertion openings in their respective receiving housings and, on the second face, two second insertion openings for electrical connectors, the two second insertion openings opening respectively into the receiving housings, the connection device comprising two connection arrangements respectively associated with the receiving housings.

5. The connection device of claim 4, wherein the electrical conductor comprises a busbar having a rigid conductive plate at an end of the busbar.

6. The connection device of claim 5, wherein the electrical connector comprises a metal jaw for clamping the electrical conductor against the terminal.

7. The connection device of claim 6, wherein the metal jaw is retained in a push piece having a shape corresponding to a shape of the second insertion opening.

8. The connection device of claim 1, wherein the electrical conductor comprises a busbar having a rigid conductive plate at an end of the busbar.

9. The connection device of claim 1, wherein the electrical connector comprises a metal jaw for clamping the electrical conductor against the terminal.

10. The connection device of claim 9, wherein the metal jaw is retained in a push piece having a shape corresponding to a shape of the second insertion opening.
